(19) United States
(12) Patent Application Publication
(10) Pub. No.: US 2012/0023421 A1
(43) Pub. Date: Jan. 26, 2012

(54) MODEL FOR EXTENSIONS TO SYSTEM PROVIDING USER INTERFACE APPLICATIONS

(75) Inventors: Hilmar Demant, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE)

(73) Assignee: SAP AG, Walldorf (DE)

(21) Appl. No.: 12/841,771

(22) Filed: Jul. 22, 2010

(51) Int. Cl. G06F 3/048; G06F 17/30

(52) U.S. Cl. 715/760; 715/765; 707/812; 707/E17.009

(57) ABSTRACT

A customized application that is declared based on an abstract class definition derived from a declared host component model associated with a host software application implementing business processes and providing a graphical display associated with a user interface (UI) for a user in a client program executing on a client frontend device storing metadata associated with the UI for the client frontend device may be initiated, the metadata including a declaration of the declared host component model and a declaration of the abstract class definition. Access to data and functionality of the host software application may be obtained via the customized application. Customized output may be provided that is different from host output provided by the host software application, the customized output generated by accessing, via the abstract class definition, the declared host component model, for accessing the same data and functionality that is accessed by the host software application.

### TECHNICAL FIELD

This description relates to models for extensions to systems providing user interface applications at client devices.

### BACKGROUND

Many businesses and organizations may utilize services (e.g., software applications) that may be provided by one or more providers that may offer user interfaces (UIs) for accessing applications that may be customized for a particular user. For example, a user may desire access via a frontend client device to customer invoice applications that are customized to that particular user. As other examples, the user may also desire access to applications for managing customer relationships, financial management, management of projects, management of supply chain networks, management of supplier relationships, support for executive management, and management of compliance with laws and regulations. Customization may be furnished by the provider, or the user may have a capability to customize particular aspects of an application or service. Further, the provider may host the software and associated data on one or more provider backend devices including host servers. The users may then access the services via remote connections (e.g., via the Internet) using various client frontend devices (e.g., a server local to the user with connecting devices, desktop computers, laptop computers, handheld devices, etc.). The users may then be able to access powerful functionality (e.g., business processes) without requiring a significant up-front investment by the user in extensive Information Technology (IT) personnel and equipment, for example, as part of the user's business setup.

However, in accessing such services via remote connections, a significant amount of processing resources may be consumed (e.g., processor time, bandwidth) by transporting service information (e.g., software and data) between the backend and the frontend devices. For example, if a user enters data into a form displayed on a client device, and the information needs to be transported to the backend for processing for each entered value in various fields, the overhead for supporting round-trip data transports may become significant. Further, if a user such as a developer needs to customize various interfaces for particular clients' needs, or to extend the backend interfaces for particular clients, programming time may become substantial in developing customized applications needing access to the backend data and functionality, and processing time may also become significant due to the added overhead of computing via several layers, between the backend and the client device.

### SUMMARY

According to one general aspect, a customized user interface manager may be configured to initiate execution of a customized application that is declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition. A customized access engine may be configured to obtain access to data and functionality of the host software application via the customized application. A customized view engine may be configured to provide customized output for the user that is different from host output provided by the host software application, the customized output generated by the customized application accessing, via the abstract class definition, the declared host component model, for accessing the same data and functionality that is accessed by the host software application.

One or more implementations may include the following features. For example, the customized output for the user may include visual output displayed on the graphical display, and the client program may be a browser. As another example, the customized output for the user may include at least one custom pane displayed on the graphical display that is a different arrangement of data that is displayed by executing the host software application.

As another example, the customized output for the user may include nonvisual output. As a further example, the customized output for the user may include triggering an event and storing a result of the event in a database.

As another example, the customized user interface manager may be configured to receive a model of the customized application and interpret the model of the customized application for execution by the client program.

As yet another example, the declared host component model may include a controller declaration configured to indicate one or more run-time event handlers, a data model declaration configured to indicate a structural description of data associated with the declared host component, an input port declaration configured to indicate one or more run-time inputs to the declared host component, and an output port declaration configured to indicate one or more run-time outputs from the declared host component.

According to another general aspect, a computer program product may be tangibly embodied on a computer-readable medium and may include executable code that, when executed, is configured to cause at least one data processing apparatus to perform the following operations. Specifically, the executable code may cause the data processing apparatus to initiate execution of a customized application that is declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition. The instructions may further cause the data processing apparatus to obtain access to data and functionality of the host software application via the customized application. The instructions may cause the data processing apparatus to provide customized output for the user that is different from host output provided by the host software application, the customized output generated by the customized application accessing, via the abstract class definition, the declared host component model, for accessing the same data and functionality that is accessed by the host software application.

One or more implementations may include the following features. For example, the customized output for the user may include visual output displayed on the graphical display, and the client program may be a browser. As another example, the customized output for the user may include at least one custom pane displayed on the graphical display that is a different arrangement of data that is displayed by executing the host software application.

As another example, the customized output for the user may include nonvisual output. As a further example, the customized output for the user may include triggering an event and storing a result of the event in a database.

As another example, the executable code, when executed, may cause the data processing apparatus to receive a model of the customized application and interpret the model of the customized application for execution by the client program.

As yet another example, the declared host component model may include a controller declaration configured to indicate one or more run-time event handlers, a data model declaration configured to indicate a structural description of data associated with the declared host component, an input port declaration configured to indicate one or more run-time inputs to the declared host component, and an output port declaration configured to indicate one or more run-time outputs from the declared host component.

According to another general aspect, a method may include initiating execution of a customized application that is declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition. The method may include obtaining access to data and functionality of the host software application via the customized application. The method may include providing customized output for the user that is different from host output provided by the host software application, the customized output generated by the customized application accessing, via the abstract class definition, the declared host component model, for accessing the same data and functionality that is accessed by the host software application.

One or more implementations may include the following features. For example, the customized output for the user may include visual output displayed on the graphical display, and the client program may be a browser. As another example, the customized output for the user may include at least one custom pane displayed on the graphical display that is a different arrangement of data that is displayed by executing the host software application.

As another example, the customized output for the user may include nonvisual output. As a further example, the customized output for the user may include triggering an event and storing a result of the event in a database.

As yet another example, the declared host component model may include a controller declaration configured to indicate one or more run-time event handlers, a data model declaration configured to indicate a structural description of data associated with the declared host component, an input port declaration configured to indicate one or more run-time inputs to the declared host component, and an output port declaration configured to indicate one or more run-time outputs from the declared host component.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for models for extensions to systems providing user interface applications at a client device.

FIG. 2 is a flowchart illustrating example operations of the system of FIG. 1.

FIG. 3 is a block diagram of an example model-view-controller structure.

FIGS. 4a-4b are block diagrams illustrating an example component structure for the system of FIG. 1.

FIG. 5 is a block diagram of an example declarative interface structure for components.

FIG. 6 is a block diagram of an example structure for a component wrapper.

FIG. 7 is a block diagram of an example runtime client for the system of FIG. 1.

FIG. 8 is a block diagram of an example runtime backend device for the system of FIG. 1.

FIG. 9 is a screen shot illustrating an example user interface screen of a sales order.

FIG. 10 is a screen shot of an example list of reports in a user interface display.

FIG. 11 is a screen shot of an example customized gallery view of reports in a user interface display.

FIG. 12 is a block diagram of an example load design for loading libraries from a model in the system of FIG. 1.

FIG. 13 is a block diagram of an example abstract custom pane.

FIG. 14 is a block diagram of an example component wrapper context.

FIG. 15 illustrates example skeleton code related to using an example custom pane.

### DETAILED DESCRIPTION

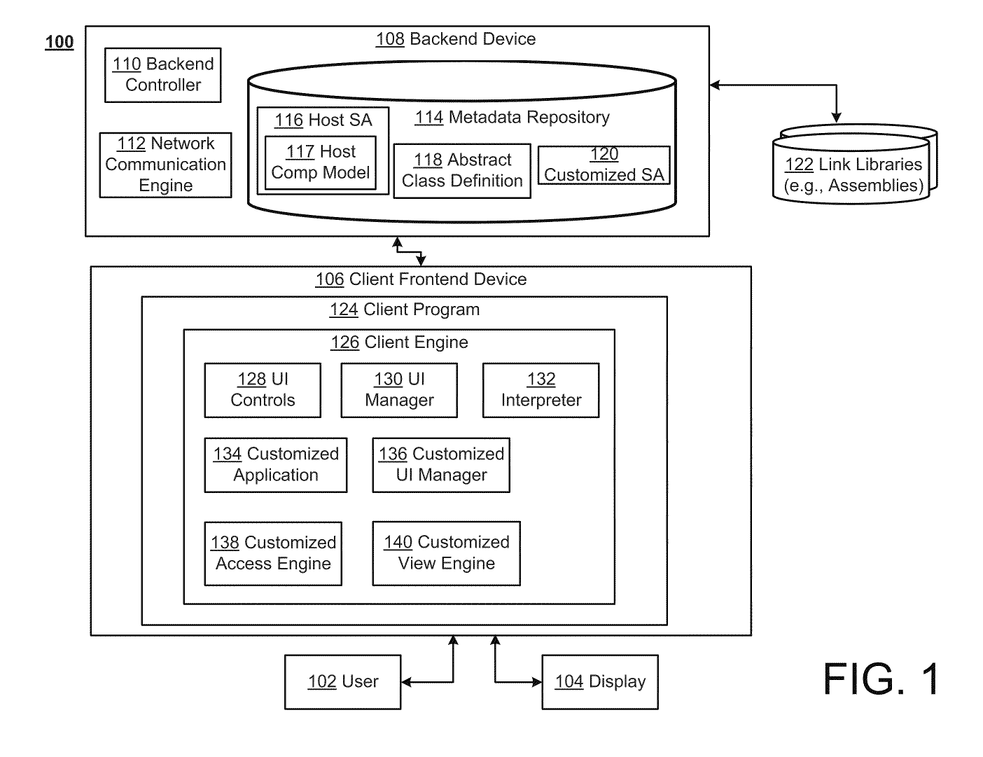

FIG. 1 is a block diagram of a system 100 for models for extensions to systems providing user interface applications at a client device. Many businesses and organizations may utilize services (e.g., software applications) that may be provided by one or more providers that may offer user interfaces (UIs) for accessing applications that may be customized for a particular user. For example, a user may desire access via a frontend client device to customer invoice applications that are customized to that particular user. As other examples, the user may also desire access to applications for managing customer relationships, financial management, management of projects, management of supply chain networks, management of supplier relationships, support for executive management, and management of compliance with laws and regulations. Customization may be furnished by the provider, or the user may have a capability to customize particular aspects of an application or service. Further, the provider may host the software and associated data on one or more provider backend devices including host servers. The users may then access the services via remote connections (e.g., via the Internet) using various client frontend devices (e.g., a server local to the user with connecting devices, desktop computers, laptop computers, handheld devices, etc.). The users may then be able to access powerful functionality (e.g., business processes) without requiring a significant up-front investment by the user in extensive Information Technology (IT) personnel and equipment, for example, as part of the user's business setup.

In the example of FIG. 1, the system 100 allows a user to generate and run customized applications based on the data and functionalities provided on a backend by the applications associated with UIs, on client devices. By generating and running such customized applications in a client program such as a browser application on the client device, the user may save significant resources in programming time and system resources, by reusing objects already developed, via an interface based on abstract class definitions to provide access to data and functionality of the UI applications. Thus, the user may obviate a need to generate applications from scratch, and obtain customized views and other customized results, using the same data and functionality already in place for the UI applications.

For example, a user may prefer a visualization of list data for attachments files in an icon view instead of simple list format. As another example, a user may prefer a customized navigation and presentation of a search result in a specific way that may be different from preferences of other users. As another example, an application help system implementation may be configured to display arbitrary HyperText Markup Language (HTML) content (from a centralized component) based on the component context.

As yet another example, an opportunity pipeline implementation may display a list of opportunities in a sales funnel view for a particular user. As another example, a customized implementation may provide a visualization of the browsing of dates for timesheet recording in a customized layout for a particular user. As yet another example, a user may prefer a visualization of an aggregation of a standard list in a graphical view, for example, using piecharts. As yet another example, a user may prefer a choice of viewing a list of reports or a gallery view of reports, as discussed below.

For example, a UI application may provide a browser window of shop floor information in a UI application. However, a user on a shop floor may not have time to stand at a client device display screen to view the window and find displayed graphical buttons that the user may need to click based on various events on the shop floor over time. Thus, the user may benefit from having a larger screen display of the same data, with the same functionality, but perhaps having much larger buttons, displayed in prominent locations, so that the user may be able to view the screen from a distance and may quickly select large buttons to push based on shop floor events. For example, a large red button may be easily recognized and clicked to trigger emergency responses in cases of emergencies on the shop floor, whereas a large green button may be easily recognized as a “green light” button to be clicked to trigger “acceptable” responses to acceptable events on the screen floor. The functionality provided by displaying and clicking such buttons may be the same for the UI application and the customized application, but the customized application may generate a different view for the user that may be easier for that particular user to use in the user's working environment. According to an example embodiment, the customized application may obtain access to the data and functionality of the UI application via an interface based on one or more abstract class definitions.

In this context, example entities such as software objects may be declared based on class definitions. Such class definitions may define structure for the software objects or other entities, at least including data and operations used by the software objects or entities. At runtime, the software objects or entities may be instantiated to generate an executable entity that may access the declared data and operations associated with the class definition. Abstract classes may be declared based on various data elements and operations of other entities, to expose, or provide access to selected data and/or operations of the other entities. Such abstract classes may not be instantiated, but may be referenced in declarations of other entities such as class definitions of other software objects, to provide runtime access to the declared data and functionality of the entities that form the basis of the declarations of the abstract classes. For example, this type of access may be accomplished by generating links or paths to link libraries or assemblies generated in association with the design of the UI applications.

In FIG. 1, one or more users 102 may use a display device 104 while connected locally to a client frontend device 106 to use user interface applications and customized applications that may be stored and served from a backend device 108. A backend controller 110 may manage operations on the backend device 108, and a network communication engine 112 may manage communication between the backend device 108 and the frontend device 106, via a network protocol, e.g., Hypertext Transfer Protocol (HTTP) or Hypertext Transfer Protocol Secure (HTTPS).

A metadata repository 114 may store information related to the UIs, such as metadata representations of the UIs that may be sent to client frontend devices for interpretation for executing the UIs on the client frontend devices 106. Since the UI information is stored on the backend device 108, one or more representations of UIs may be viewed (as an aggregate of the UI's metadata) as a host software application 116 that is downloaded to client frontend devices 106 for interpretation and execution. According to an example embodiment, the UI metadata may be implemented in eXtensible Markup Language (XML), and may include descriptive data such as processes to be executed, display information such as buttons, data entry fields, display fields, and information related to input/output data associated with the UI. According to an example embodiment, the host software application 116 may include a host component model 117, as discussed further herein.

The metadata repository 114 may also store one or more abstract class definitions 118, that may be based on data and or operations of one or more of the host software applications, or other entities. Further, the metadata repository 114 may store one or more customized software applications 120 based on one or more of the host software applications 116, via one or more abstract class definitions 118. For example, a host sales order UI application 116 may access data and functionality for displaying queries to a user, and for receiving input related to particular sales orders. An abstract class definition 118 may provide access to the data and functionality of the host UI application 116, and one of the customized software applications 120 may provide a different, customized view to the user 102, of the same data and functionality provided by the host UI application. For example, the user 102 may view a display of a pane showing line-by-line numbers associated with sales orders in a browser window that is generated based on the host UI application 116, and may simultaneously view a custom pane of the same information, but displayed as a customized bar graph in the custom pane.

Link libraries 122 associated with the host software applications 116 and customized software applications 120 may be stored in the metadata repository 114, or may be stored in repositories local to the backend device, or remote from the backend device (e.g., via networks such as the Internet). For example, the link libraries may include Dynamic Link Libraries (dll's) and/or assemblies that may include data and/or code available at link time for applications that reference the link libraries.

The client frontend device 106 may include a client program 124 that may be used for executing processes associated with the UIs, for sending information to the user 102, for receiving input from the user 102, and for displaying images on the display 104 for the user, as well as managing a flow of information between the client program 124 and the backend device 108. For example, the client program may include a browser, such as Internet Explorer, Firefox, or Chrome. For example, a browser may include a plugin such as Microsoft Silverlight to handle execution of the processes associated with the UIs and displaying information on the display 104 for the user 102. Such a client program or browser plugin may include a graphical subsystem for rendering user interfaces in Windows-based applications, which may provide a consistent programming model for building applications and provide a clear separation between the user interface and business logic. Using such a browser plugin, for example, may eliminate a need for a Java stack (e.g., a Java J2EE server stack) for execution of processes on the client frontend device 106, thereby providing an environment using a more lean stack for execution and communication. Such an environment may provide a more efficient and more timely execution of processes related to the needs of the user 102. In an example implementation, the client program may be run independently of a browser. Other applications that may be used may include ASP.NET, Flash, or Java (e.g., Java EE 6).

A client engine 126 may include UI controls 128, a UI manager 130, and an interpreter 132. The UI controls 128 may be configured to manage control structures related to a UI (e.g., input fields, drop boxes, tables, charts, etc.). The UI manager 130 may be configured to manage interpretation of the UIs via the interpreter 132, as well as any input and output between the UIs and the user 102 or operations between the UI and the backend device 108. For example, the UI manager 130 may receive a metadata representation of a UI, and may request its interpretation via the interpreter 132 so that a graphical display may be rendered on the display device 104 for interaction with the user 102.

The client engine 126 may further include a customized application 134 that may include information for executing a customized view of a host application 116 for a particular client user. Information associated with the customized application 134 may be stored in the metadata repository 114 (e.g., the customized software application 120) for retrieval by the client engine 126 for loading and execution via the interpreter 132. For example, the customized application 134 may be configured to access data and/or functionality provided by one or more host software applications 116 via one or more abstract class definitions 118.

A customized user interface manager 136 may be configured to initiate execution of a customized application (e.g., the customized application 134) that is declared based on an abstract class definition (e.g., the abstract class definition 118) derived from a declared host component model 117 associated with a host software application (e.g., the host software application 116) implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition.

According to an example embodiment, the customized user interface manager 136 may be configured to receive a model of the customized application 120 and interpret the model of the customized application 120 for execution by the client program 124 (e.g., via the interpreter 132).

A customized access engine 138 may be configured to obtain access to data and functionality of the host software application 116 via the customized application 120, as discussed further herein. A customized view engine 140 may be configured to provide customized output for the user 102 that is different from host output provided by the host software application 116, the customized output generated by the customized application 134 accessing, via the abstract class definition 118, the declared host component model, for accessing the same data and functionality that is accessed by the host software application 116, as further discussed herein.

According to an example embodiment, the customized output for the user may include visual output displayed on the graphical display, and the client program may be a browser. For example, the customized output for the user may include at least one custom pane displayed on the graphical display that is a different arrangement of data that is displayed by executing the host software application 116. For example, the host software application 116 may provide a display of a list of numbers, while the customized output may include a simultaneously displayed custom pane showing bar charts generated from the same data and functionality used by the host software application 116 for its display of the list of numbers.

According to an example embodiment, the customized output for the user may include nonvisual output. For example, the customized output for the user may include triggering an event and storing a result of the event in a database. For example, the user may wish to initiate a query and store results of the query in a user database, based on events that may occur during execution of the host software application 116. The customized application 134 may thus be configured to receive an alert from the functionality of the host software application 116, and may determine whether the query should be processed, and may store query results, if desired, without visual output to the user 102.

According to an example embodiment, the declared host component model 117 may include a controller declaration configured to indicate one or more run-time event handlers, a data model declaration configured to indicate a structural description of data associated with the declared host component, an input port declaration configured to indicate one or more run-time inputs to the declared host component, and an output port declaration configured to indicate one or more run-time outputs from the declared host component, as discussed further below.

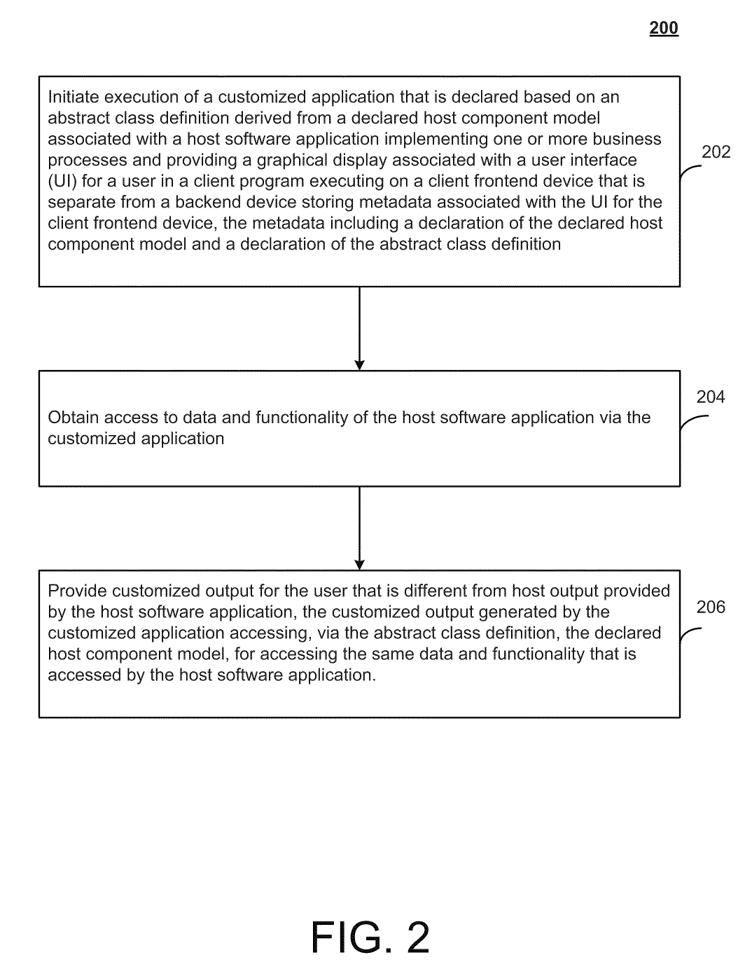

FIG. 2 is a flowchart 200 illustrating example operations of the system of FIG. 1. In the example of FIG. 2, execution of a customized application may be initiated. The customized application may be declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition (202).

For example, the customized user interface manager 136 of FIG. 1 may initiate execution of the customized application 134. As discussed previously, the customized application (e.g., the customized application 134) may be declared based on an abstract class definition (e.g., the abstract class definition 118) derived from the declared host component model 117 associated with the host software application (e.g., the host software application 116) implementing one or more business processes and providing a graphical display associated with the user interface (UI) for a user in a client program executing on a client frontend device that is separate from a backend device storing metadata associated with the UI for the client frontend device, the metadata including a declaration of the declared host component model 117 and a declaration of the abstract class definition 118.

Access to data and functionality of the host software application may be obtained via the customized application (204). For example, the customized access engine 138 may be configured to obtain access to data and functionality of the host software application 116 via the customized application 120, as discussed further herein. A customized view engine 140 may be configured to provide customized output for the user 102 that is different from host output provided by the host software application 116, the customized output generated by the customized application 134 accessing, via the abstract class definition 118, the declared host component model, for accessing the same data and functionality that is accessed by the host software application 116, as further discussed herein.

Customized output for the user that is different from host output provided by the host software application may be provided, the customized output generated by the customized application accessing, via the abstract class definition, the declared host component model, for accessing the same data and functionality that is accessed by the host software application. (206).

For example, the customized view engine 140 may provide customized output for the user 102 that is different from host output provided by the host software application 116, the customized output generated by the customized application 134 accessing, via the abstract class definition 118, the declared host component model, for accessing the same data and functionality that is accessed by the host software application 116, as discussed previously.

According to an example embodiment, the customized output for the user may include visual output displayed on the graphical display, and the client program may be a browser. For example, the customized output for the user may include at least one custom pane displayed on the graphical display that is a different arrangement of data that is displayed by executing the host software application 116. For example, the host software application 116 may provide a display of a list of numbers, while the customized output may include a simultaneously displayed custom pane showing bar charts generated from the same data and functionality used by the host software application 116 for its display of the list of numbers.

According to an example embodiment, the customized output for the user may include nonvisual output. For example, the customized output for the user may include triggering an event and storing a result of the event in a database. For example, the user may wish to initiate a query and store results of the query in a user database, based on events that may occur during execution of the host software application 116. The customized application 134 may thus be configured to receive an alert from the functionality of the host software application 116, and may determine whether the query should be processed, and may store query results, if desired, without visual output to the user 102.

According to an example embodiment, the declared host component model 117 may include a controller declaration configured to indicate one or more run-time event handlers, a data model declaration configured to indicate a structural description of data associated with the declared host component, an input port declaration configured to indicate one or more run-time inputs to the declared host component, and an output port declaration configured to indicate one or more run-time outputs from the declared host component, as discussed further below.

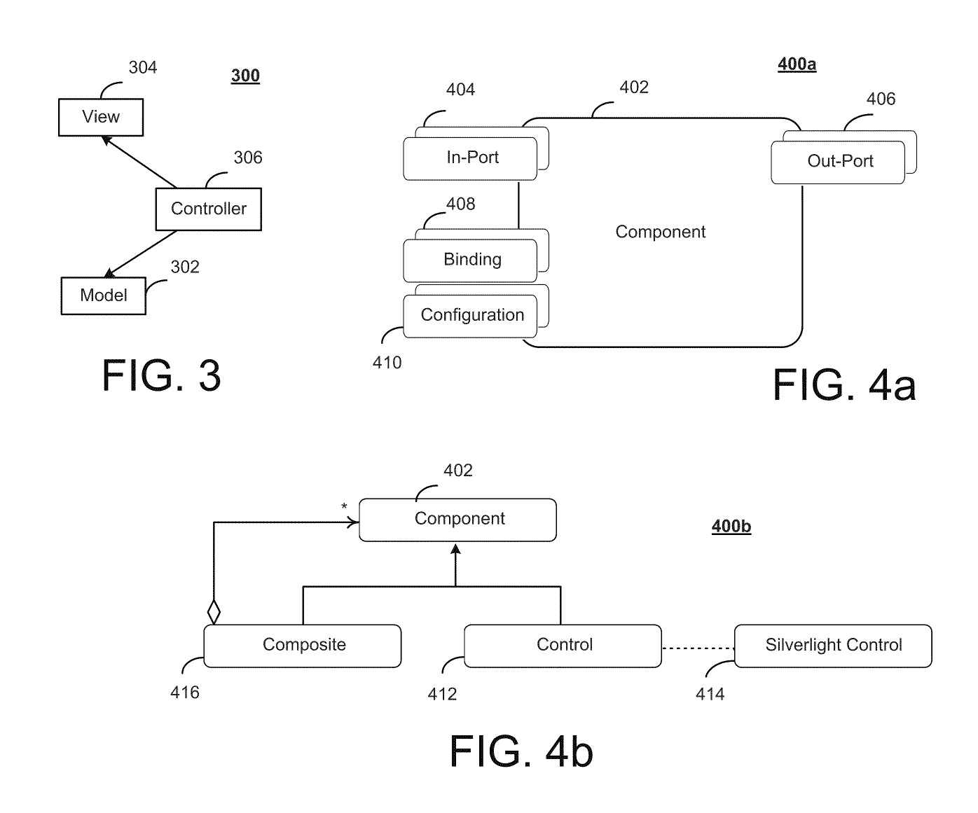

FIG. 3 is a block diagram of an example model-view-controller structure 300. Model-view-controller (MVC) is an architectural pattern used in software engineering. In an MVC context, a model 302 may represent information or data of an application. A view 304 may correspond to elements of a user interface such as text, buttons, checkbox items, etc. A controller 306 manages the communication of data and the rules used to manipulate the data to and from the model. FIG. 3 shows the dependencies among the model 302, view, 304, and the controller 306.

FIGS. 4a-4b are block diagrams illustrating an example component structure for the system of FIG. 1. According to an example embodiment, a UI component 402 may include a self contained model of a UI that may be declaratively used in another UI model. A declarative interface 400a of a UI component 402 may include in-ports 404 and out-ports 406. These ports may be used to implement a loosely coupled behavior in embedding or navigation scenarios. The data of a loosely coupled component may be loaded asynchronous (i.e., an additional roundtrip between the frontend and backend may be needed). The declarative interface 402 may also include binding 408, for tightly coupled behavior in embed scenarios (e.g., synchronous loading), working directly on the data model of a parent UI model (e.g., via references to the parent data model). The declarative interface 400a may also include configuration 410. A technical configuration may be exposed, e.g., to enable a user to support different styles/flavors, e.g., statically set at design time.

As shown in a logical component model 400b of FIG. 4b, a component 402 may be a control 412 provided by a system framework or implemented in association with framework controls (e.g., a Silverlight control 414). A component 402 may be a composite 416 (e.g., composite control, building block, etc.) which may include other components (e.g., nested composites and/or controls). Components 402 may expose an interface or interfaces for actions, ports and bindings. A composite may be used and configured in a view-composition or used as the target of a navigation as a standalone UI application. The configuration of a non-framework component may be generated via the exposed declared interface.

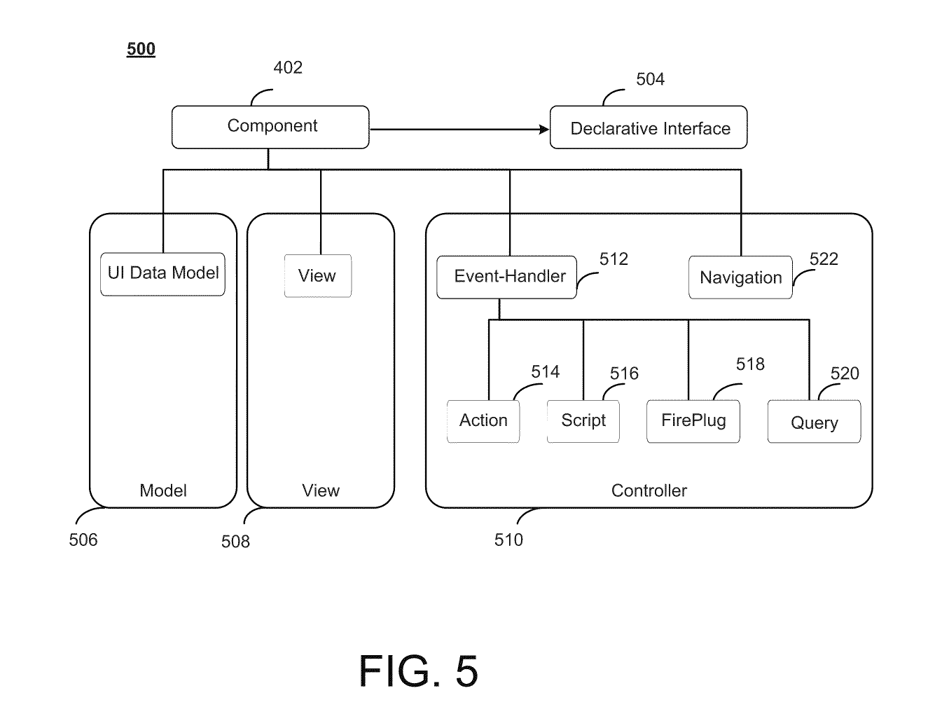

FIG. 5 is a block diagram of an example declarative interface structure 500 for components. A component 402 may include a declarative interface 504, a model 506, a view 508, and a controller 510. For example, a view 508 may include a description of the user interface which binds to a UI data model 506 and triggers event-handlers 512. The UI data model 506 may describe data structure, which can bind to backend data. The controller 510 may recognize various types of event-handlers 512 such as business object actions 514, script 516, plug-operations 518 and queries 520. According to an example embodiment, navigation 522 may include a context-mapping for outplug-inplug-operations. The declarative interface 504 may expose ports, binding-capabilities and configuration to the composition environment.

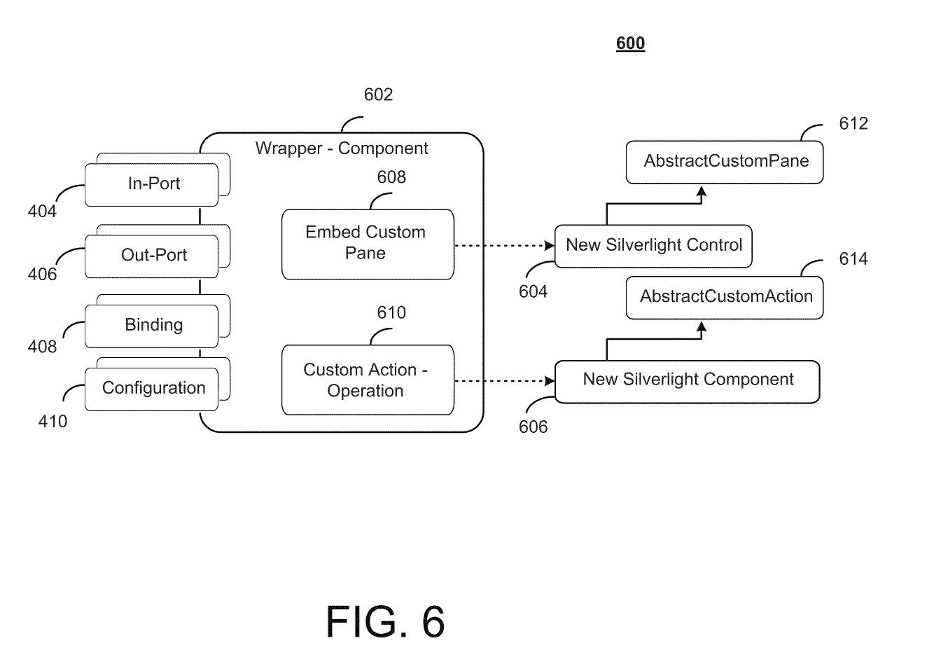

FIG. 6 is a block diagram of an example structure 600 for a component wrapper 602. According to an example embodiment, native Silverlight components may be generated (e.g., Silverlight control 604, Silverlight component 606) which can interact with the component data model and may participate in events. A developer may implement interfaces and use these components via a custom pane 608 in an EmbedComponent-Type, and via a custom action operation 610, respectively. Through this a declared interface wrapper may use these components in other components. Custom panes may be utilized via EmbedComponents and may be associated with a control derived from AbstractCustomPane 616 for controls or from Abstract CustomAction 614 for action components. According to an example implementation, custom panes that are configured in EmbedComponents may point to an assembly name and class type name of a control derived from the framework AbstractCustomPane. Embedcomponents may be used in other components, as this provides a capability at designtime to reflect on the declarative interface of the wrapper component.

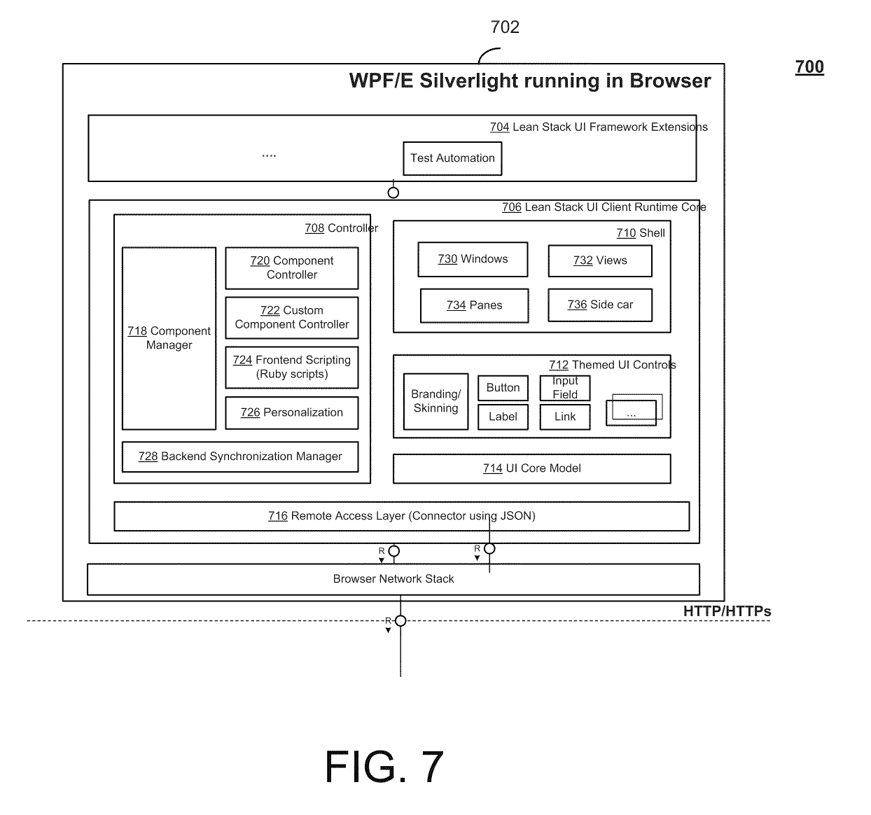

FIG. 7 is a block diagram of an example runtime client 700 for the system of FIG. 1. As shown in FIG. 7, Silverlight 702 is running in the client program 124 (e.g., a browser) of FIG. 1. The system includes lean stack UI framework extensions 704, which includes test automation for testing UIs as discussed herein. The system further includes a lean stack UI client runtime core 706, which includes a controller 708, a shell 710, themed UI controls 712, a UI core model 714, and a remote access layer 716. The controller 708 includes a component manager 718 for managing components, which were discussed previously. The controller 708 also includes a component controller 720, a custom component controller 722, a frontend scripting engine 724, a personalization engine 726, and a backend synchronization manager 728. The shell 710 includes windows 730, views 732, panes 734, and side cars 736.

User requests may be triggered on the client side during UI runtime. The first user request may be a navigation request that results in a request to the backend to read a UI component. The UI component is read from a central metadata repository in the backend and transported to the frontend. The component manager 718 may instantiate the UI component and a corresponding component controller 720 for the UI component on the client side and triggers the initialization of the UI component on the backend side. The component manager 718 generates a control tree for the UI component out of the controls provided in a central “Themed Controls” 712 package. These controls ensure uniform look and feel and the ability to change themes consistently. The controls in the “themed UI controls” package may be enabled in a consistent way for test automation and accessibility, and may be provided in a manner such that all native implemented custom UI panes may use the controls. More than one UI component may be needed to render a UI, as UI components may embed other UI components (e.g., a Work Center component may embed a Work Center View Component and they again may embed OWL components, etc.). The top-level UI component that is rendered is a root UI component which renders a common frame for all UI components, e.g., by rendering the top level navigation and has an ability to open a side car for personalization and help.

For each UI component the “generic” component controller 720 for that particular component is instantiated. If a custom UI pane is to be rendered then a corresponding custom component controller 722 may be instantiated. The component controller 720 ensures that all controls are bound to the proper fields of the UI model and executes all operations that are configured in the event handlers of the UI component. If, some script segments are discovered in the event handlers, the controller triggers the execution of these scripts in the frontend scripting engine 724. The component controller 720 may also trigger a roundtrip to the backend device 108. In that case the backend synchronization manager 728 identifies all changed data in the UI data model in the client and packs only the changed data in a request to the backend. After the backend controller computes the data in the backend all changed data and only the changed data from the backend (including all data changed via side effects) may be transported back to the frontend.

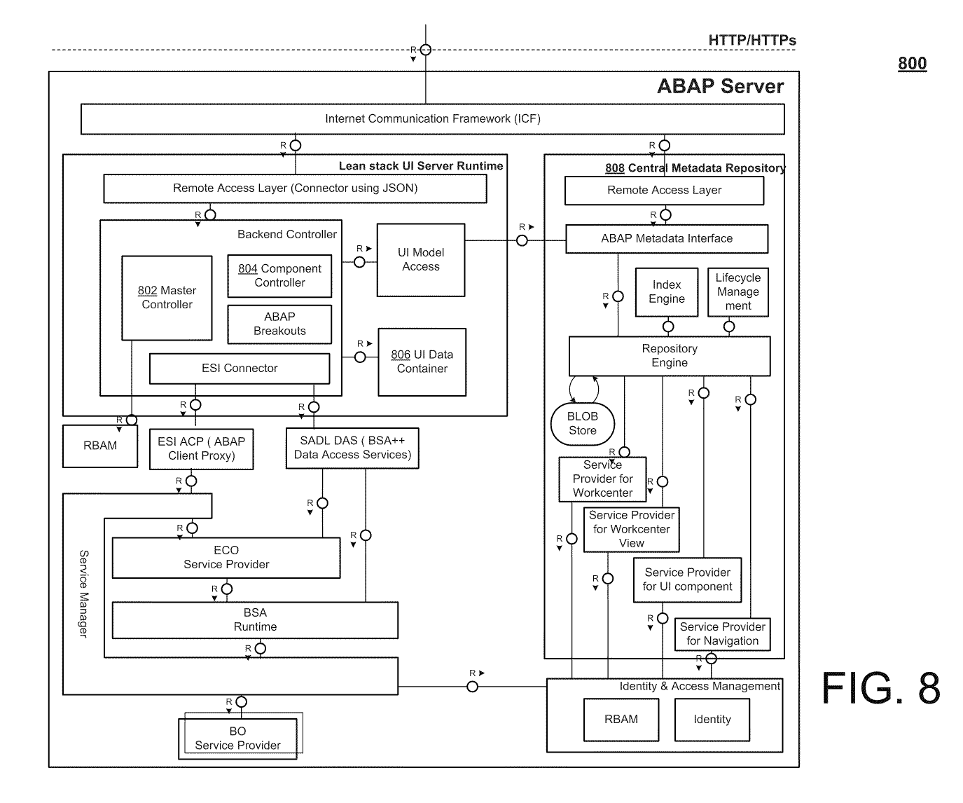

FIG. 8 is a block diagram of an example runtime backend device 800 for the system of FIG. 1.

After the client runtime 700 (as discussed above) triggers the initialization of a UI component in the backend for a first time in a session, the UI server runtime 800 may first create a master controller 802 for the complete session and then may generate a component controller 804 for each component that is requested from the client runtime 700. Each component controller 804 may build a UI data container 806 from the information of the UI model for a component. The master controller 802 may handle the choreography of the different controllers and may build a bracket for all operations targeted for one controller. The master controller 802 may also trigger another runtime and provide the other runtime with all relevant metadata. Relevant information is stored within the models of the UI components.

After the master controller 802 has processed all component controllers 804, it collects all the data that has changed in the UI data container 806 and transports all changed data to the client.

As discussed previously, the UI components may be stored in a central metadata repository 808 (e.g., similar to metadata repository 114) on the backend device 108.

According to an example embodiment, communications between components may be modeled via semantic navigation targets. In this instance, target components are not named directly, but navigation may be invoked based on a host business object and an operation. An operation may be a standard-operation (e.g., display, edit, list, etc.) or a custom operation introduced in a navigation registry. The in- and out-ports of a UI component may be used in the definition of a navigation to identify the involved UI components for the runtime.

A navigation provider may thus replace dynamically at component load/generation time the semantic navigation targets by UI components. This concept allows flexibility regarding determination of navigation targets according to use cases. The semantics of a business object and an operation (e.g., SalesOrder-Open) may be used as a navigation query for requesting a navigation target. Each application UI to be used as a navigation target defines a business object and an operation name as navigation target descriptor to indicate which navigation requests it supports.

To support some special use cases (e.g., globalization, verticalization) a third parameter beside business object and operation may be made available which has no fixed semantic but can be defined by the applications (e.g., in some cases this third parameter is the country for which a special UI component has to be launched).

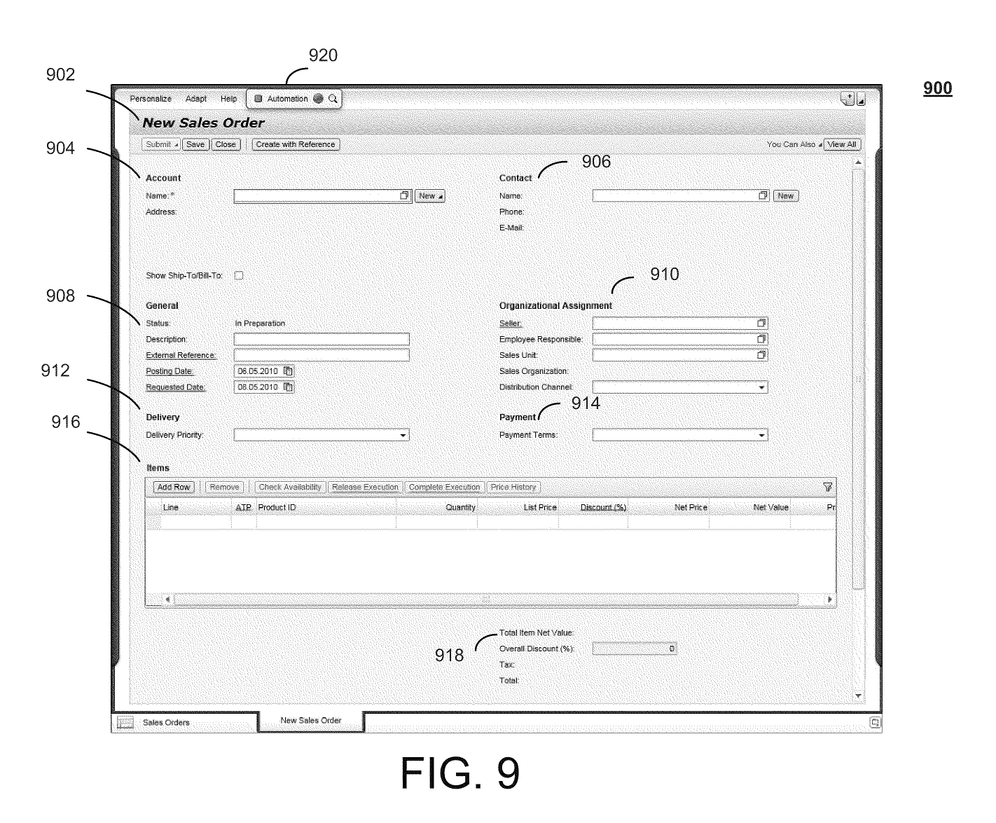

FIG. 9 is a screen shot illustrating an example user interface screen 900 of a sales order 902. As shown in FIG. 9, the sales order screen may be displayed on the display 104 for viewing and use by the user 102, as discussed previously. The sales order screen 902 includes several fields associated with a sales order, such as account name 904, contact information 906, status of the sales order 908, organizational assignment 910, delivery priority 912, payment terms 914, items to be sold 916, and total for payment 918. As shown in FIG. 9, a graphical display symbol (shown as a button on the top of the display) indicates “Automation,” enabling the user 102 to access an automation center by clicking on the button, while still executing the application for new sales order 902. For example, the user 102 may record a script of events that occur while the user is accessing the sales order application, and may store the recorded script, or may play the recorded script for testing purposes.

There are many examples of user applications that may be implemented as custom panes by the system of FIG. 1. For example, an IconViewPane custom pane implementation may provide a visualization of list data for attachments files in an icon view instead of simple list format. As another example, an EnterpriseSearch custom pane implementation may provide a search result and navigation in a specific way that may be customized for a specific client.

As another example, a HelpCenter custom pane implementation may display arbitrary HyperText Markup Language (HTML) content (from a centralized component) based on the component context for an application help system. As yet another example, an OpportunityPipeline custom pane implementation may display a list of Opportunities in a SalesFunnel view for a particular user.

As another example, an HCMTimeSheet custom pane implementation may provide a visualization of the browsing of dates for timesheet recording in a customized layout for a particular user. As yet another example, an AnalyticalOWL custom pane implementation may provide a visualization of an aggregation of a standard list in a graphical view, for example, using piecharts.

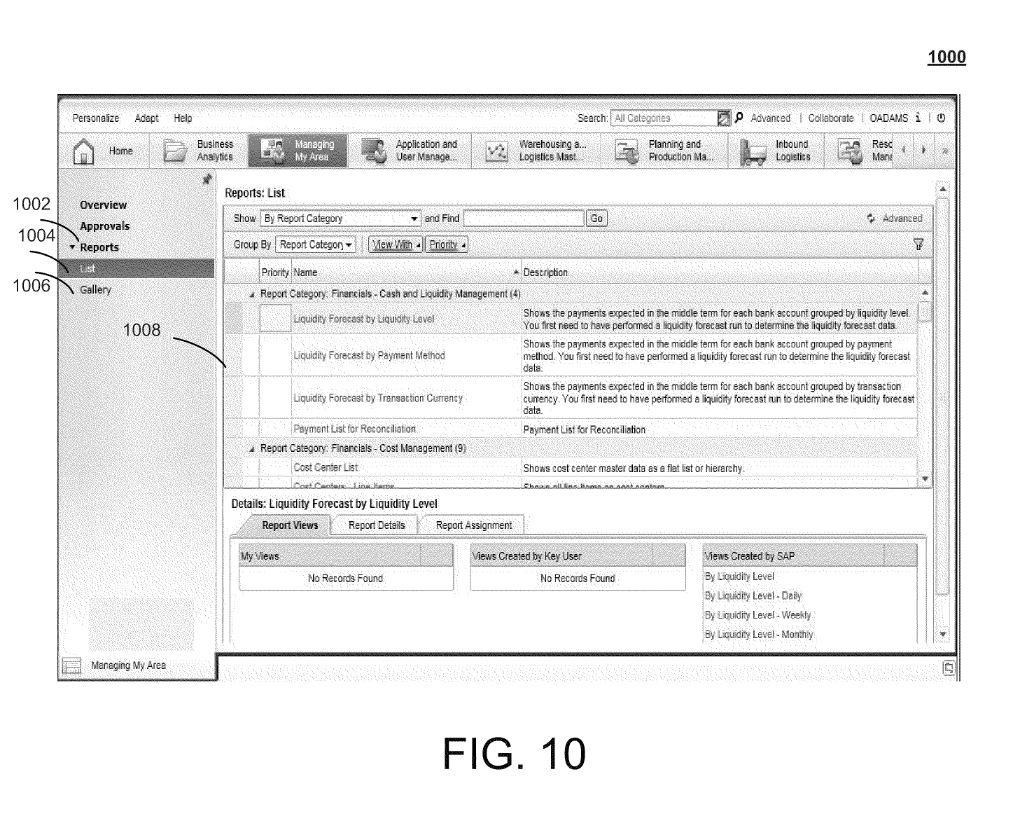

FIG. 10 is a screen shot of an example list of reports 1000 in a user interface display. As shown in FIG. 10, a left pane of a window indicates a selection of types of report views 1002 that may be viewed by the user 102. As shown, the user may select the reports to be displayed either as a list view 1004 of reports, or as a gallery view 1006 of reports. As shown in FIG. 10, the list view 1004 may be selected to generate a view 1008 showing a list of reports for the user 102.

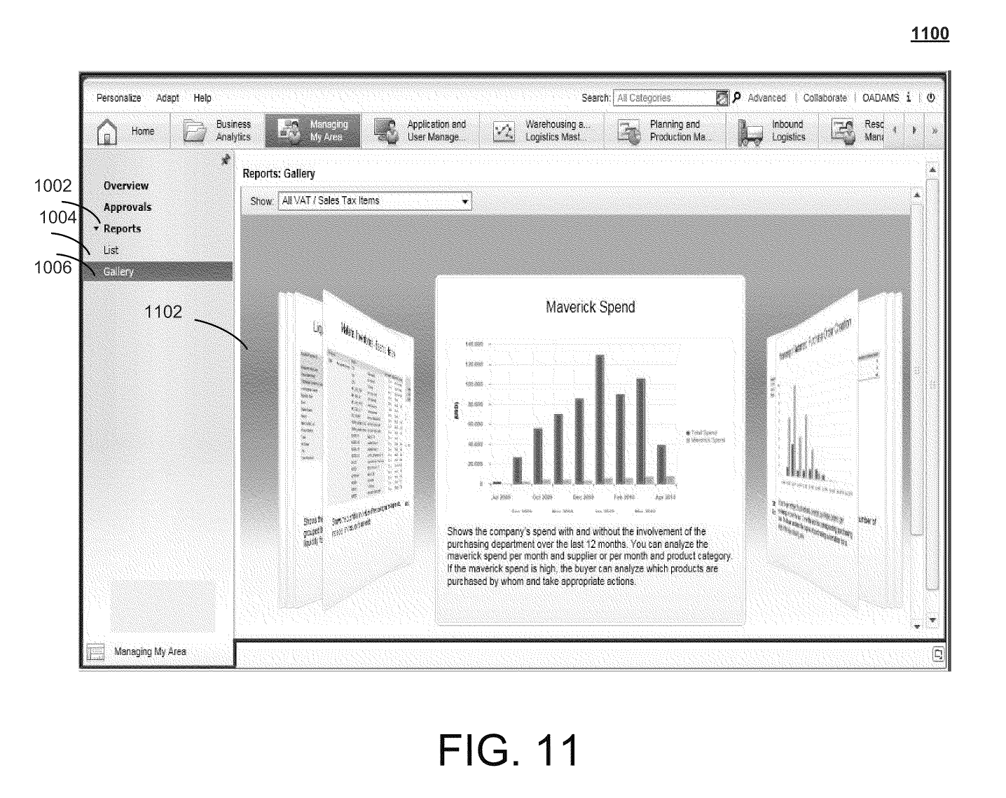

FIG. 11 is a screen shot of an example customized gallery view 1100 of reports in a user interface display. As discussed previously with regard to FOG. 10, the user 102 may select either a list view 1004 of reports, or a gallery view 1006 of reports. As shown in FIG. 11, the gallery view 1006 may be selected to generate a view 1102 showing a gallery of reports for the user 102 in various graphical formats such as graphs, tables, and charts. As discussed previously, the same component model may be used to generate each of the list pane 1008 of FIG. 10 and the gallery pane 1102, utilizing a custom pane implementation to achieve a different UI visualization for each type of report request.

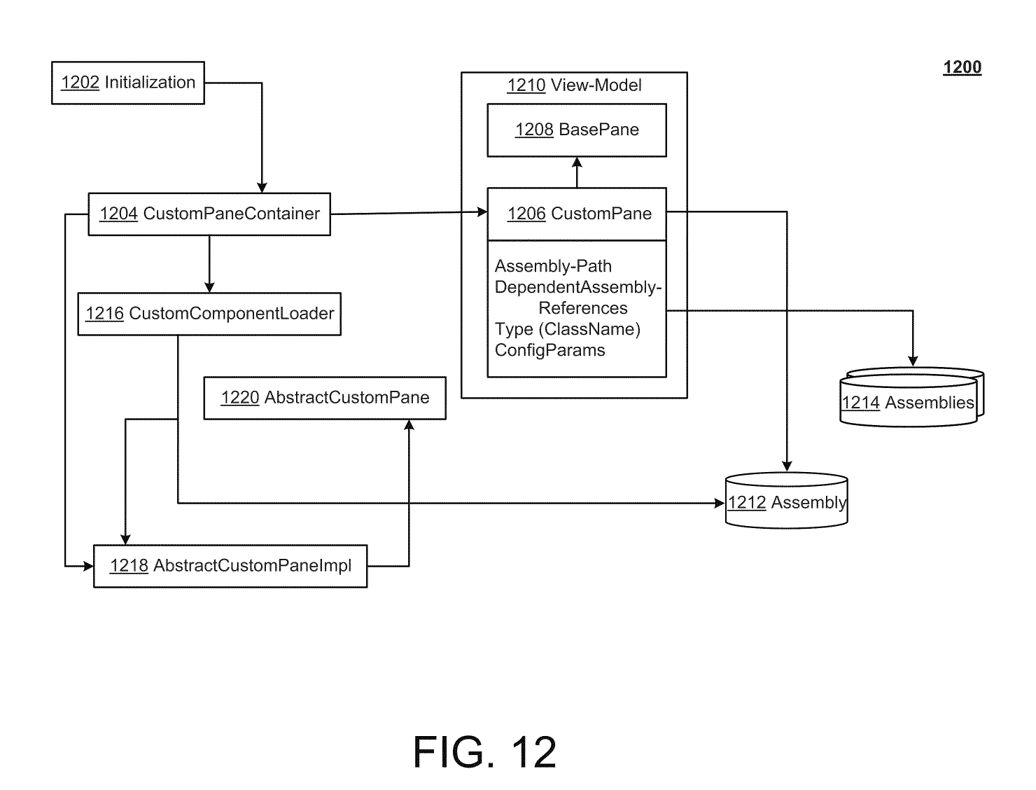

FIG. 12 is a block diagram of an example load design 1200 for loading libraries from a model in the system of FIG. 1. During rendering intialization 1202 a CustomPaneContainer 1204 may be generated with a reference to its model-configuration CustomPane 1206. The CustomPane 1206 may be derived from a BasePane 1208 that is included in a View-Model 1210. The CustomPane 1206 may include a reference to one or more assemblies 1214 to provide access information for link libraries that may be used for implementing the CustomPane 1206. The CustomPane 1206 may include assembly paths, dependent assembly references, types, and configuration parameters, which may provide access information for assemblies 1214 which may be needed in order to implement the CustomPane 1206.

With CustomPaneContainer 1204 a CustomComponentLoader 1216 may be launched to dynamically instantiate an implementation 1218 of the AbstractCustomPane 1220. A desired type (e.g., a class name) may require access to multiple assemblies, as one assembly may include multiple custom pane implementations. Thus, the main assembly and dependent assemblies may need to be loaded.

According to an example embodiment, a control may be generated and inserted into composition tree. In a CustomPane implementation, connection points based through the AbstractCustomPane 1220 may now be used to communicate.

A similar type of loading may be used for an example CustomAction, except that a CustomActionOperation which may reference a customaction-assembly containing the implementation for the operation may be used as a defining declaration instead of the CustomPane 1206 in the View-Model 1210.

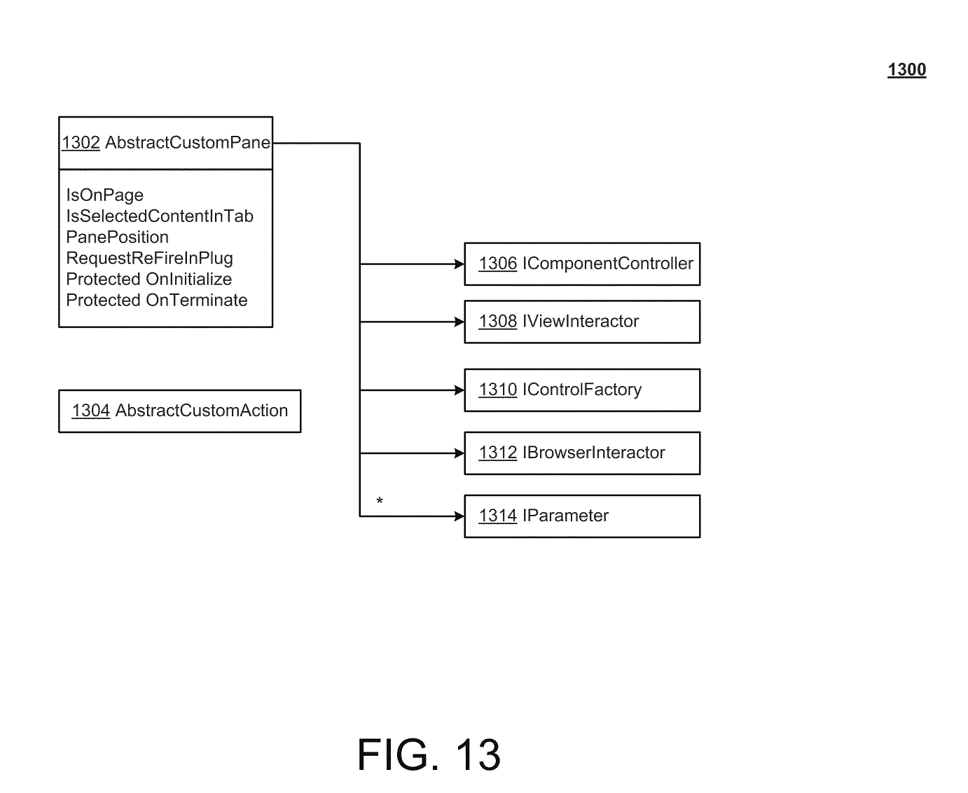

FIG. 13 is a block diagram of an example abstract custom pane 1300. According to an example implementation, Application Programming Interfaces (APIs) may provide access to a runtime context of the system of FIG. 1. For example, an AbstractCustomPane API 1302 or AbstractCustomAction API 1304 may provide access to a runtime context of the system of FIG. 1.

For example, a custom pane may obtain access to the controller context of the runtime environment via an IComponentController 1306. The custom pane may obtain access to a session and a component definition. A data model container may read and manipulate the actual values in the system. Events and navigations defined in a component may also be triggered. Through an open access to system elements may also be possible to register to various system events, such as modifications of data values.

An IViewInteractor 1308 may provide information regarding a view area of the custom pane at runtime (e.g., the position of the custom pane in a scroll area). The IViewInteractor 1308 may also provide the user with a mean for determining an available width and height in the embedded state and for participating in resizing events.

A developer of custom panes may create bound controls similarly as in declared models of the system 100 via an IControlFactory 1310. Thus, behavior and constraints from the framework implementation may be used by the custom pane UI. Further, the custom pane UI may participate in activities such as theming actions and update of styles.

A custom pane may obtain access to an HTML-container specific context and may generate an iFrame with external HTML content via an IBrowserInteractor 1312. Additionally, a list IParameter 1314 may provide access to model parameters which may be set in declarative model descriptions for a particular usage of a custom pane. A custom pane implementation may retrieve the values of the parameters and react to the values in accordance with the configuration of the custom pane.

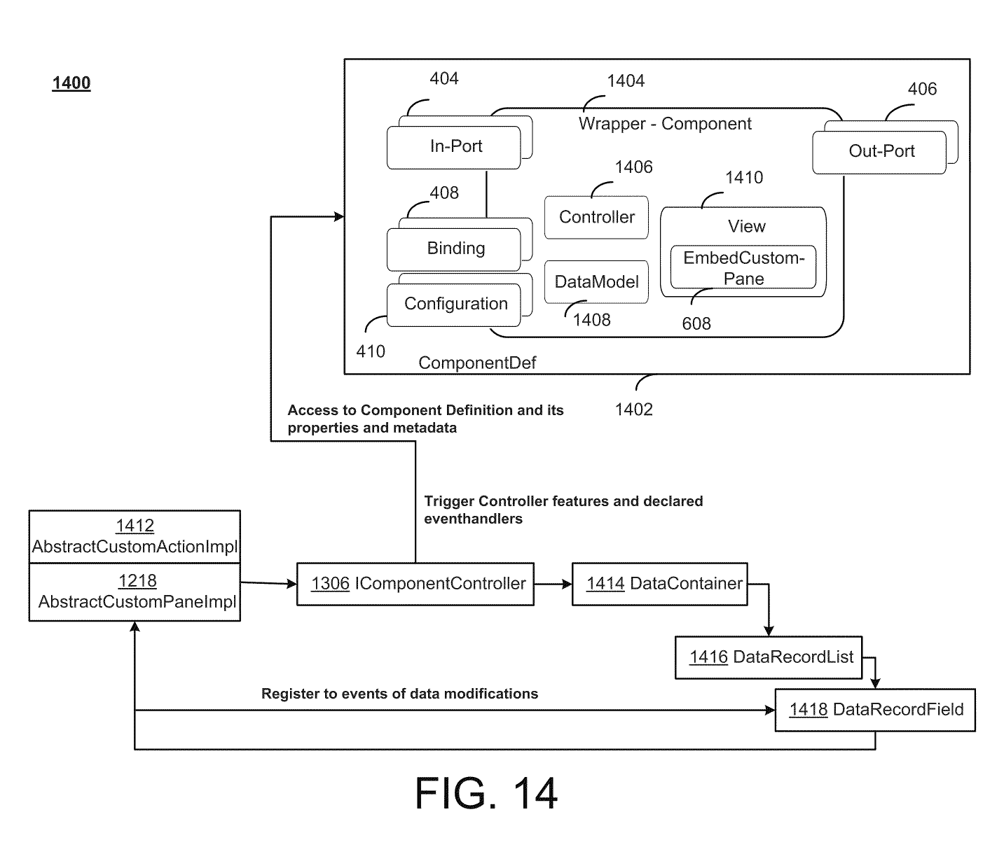

FIG. 14 is a block diagram of an example component wrapper context 1400. The component wrapper context 1400 may provide a user with a mix of custom implementation techniques and access to declared framework functionality. As shown in FIG. 14, a component definition 1402 includes a component wrapper 1404. The component wrapper 1404 may include a controller 1406, a data model 1408, a view 1410 which includes the EmbedCustomPane 608, and the wrapper interface, as discussed previously.

The IComponentController 1306 may be included in an abstract custom action implementation 1412 or the abstract custom pane implementation 1218, and may trigger controllers and event handlers declared in the component definition 1402. As discussed previously, the IComponentController 1306 may be included in a customized implementation, and may access the component definition 1402 and its properties and metadata. The IComponentController 1306 may access a data container 1414, which may access a data record list 1416 and a data record field 1418. The abstract custom pane implementation 1218 and abstract custom action implementation 1412 may register to events involving modifications of data values. For example, if a data value is modified by a host application, then the abstract custom pane implementation 1218 and abstract custom action implementation 1412 may be informed of the modification, and may react to it accordingly. For example, if the custom pane implementation is displaying a data value that is modified by the host application, then the custom pane implementation may update its display of the value.

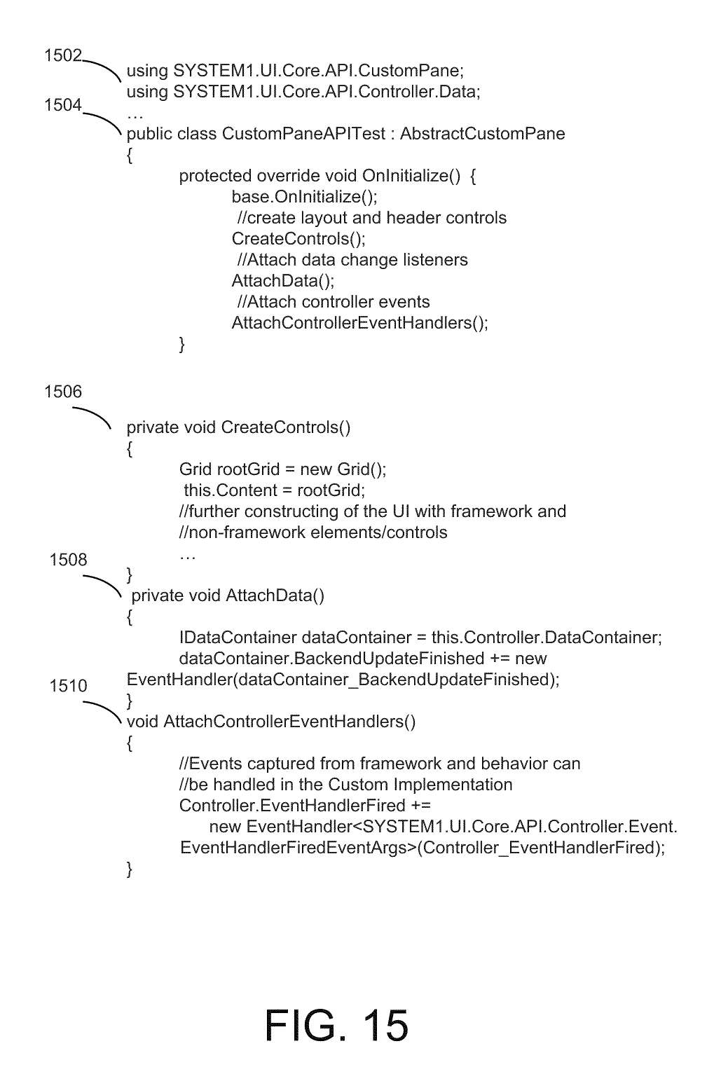

FIG. 15 illustrates example skeleton code 1500 related to using an example custom pane. As shown in FIG. 15, the custom pane is declared to use a system pane and controller data at 1502. An abstract custom pane is referenced (and an abstract process OnInitialize is overridden) at 1504. In the example of FIG. 15, layout and header controls are generated via CreateControls 1506, on initialization of an abstract custom pane. Data change listeners are attached via AttachData 1508. Controller event handlers are also attached via AttachControllerEventHandlers 1510. Thus, events within the framework may be detected and captured, and the behavior of the events may be handled or processed within the custom pane implementation.

As described, the techniques of the present description may be provided to enable users to generate customized views and other customized entities via an abstract class providing access to data and functionality of the framework supporting user interfaces in a lean stack client frontend environment.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program that might implement the techniques mentioned above might be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a customized user interface manager configured to initiate execution of a customized application that is declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition;
a customized access engine configured to obtain access to data and functionality of the host software application via the customized application; and
a customized view engine configured to provide customized output for the user that is different from host output provided by the host software application, the customized output generated by the customized application accessing, via the abstract class definition, the declared host component model, for accessing the same data and functionality that is accessed by the host software application.

2. The system of claim 1 wherein:
the customized output for the user includes visual output displayed on the graphical display, and
the client program is a browser.

3. The system of claim 2 wherein:
the customized output for the user includes at least one custom pane displayed on the graphical display that is a different arrangement of data that is displayed by executing the host software application.

4. The system of claim 1 wherein:
the customized output for the user includes nonvisual output.

5. The system of claim 4 wherein:
the customized output for the user includes triggering an event and storing a result of the event in a database.

6. The system of claim 1 wherein:
the customized user interface manager is configured to:
receive a model of the customized application; and
interpret the model of the customized application for execution by the client program.

7. The system of claim 1 wherein the declared host component model includes:
a controller declaration configured to indicate one or more run-time event handlers;
a data model declaration configured to indicate a structural description of data associated with the declared host component;
an input port declaration configured to indicate one or more run-time inputs to the declared host component; and
an output port declaration configured to indicate one or more run-time outputs from the declared host component.

8. A computer program product tangibly embodied on a computer-readable medium and including executable code that, when executed, is configured to cause at least one data processing apparatus to:
initiate execution of a customized application that is declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition;
obtain access to data and functionality of the host software application via the customized application; and
provide customized output for the user that is different from host output provided by the host software application, the customized output generated by the customized application accessing, via the abstract class definition, the declared host component model, for accessing the same data and functionality that is accessed by the host software application.

9. The computer program product of claim 8 wherein:
the customized output for the user includes visual output displayed on the graphical display, and
the client program is a browser.

10. The computer program product of claim 9 wherein:
the customized output for the user includes at least one custom pane displayed on the graphical display that is a different arrangement of data that is displayed by executing the host software application.

11. The computer program product of claim 8 wherein:
the customized output for the user includes nonvisual output.

12. The computer program product of claim 11 wherein:
the customized output for the user includes triggering an event and storing a result of the event in a database.

13. The computer program product of claim 8 wherein the executable code, when executed, is configured to cause the at least one data processing apparatus to:
receive a model of the customized application; and
interpret the model of the customized application for execution by the client program.

14. The computer program product of claim 8 wherein the declared host component model includes:
a controller declaration configured to indicate one or more run-time event handlers;
a data model declaration configured to indicate a structural description of data associated with the declared host component;
an input port declaration configured to indicate one or more run-time inputs to the declared host component; and
an output port declaration configured to indicate one or more run-time outputs from the declared host component.

15. A method comprising:
initiating execution of a customized application that is declared based on an abstract class definition derived from a declared host component model associated with a host software application implementing one or more business processes and providing a graphical display associated with a user interface (UI) for a user in a client program executing on a client frontend device that is separate from a backend device storing metadata associated with the UI for the client frontend device, the metadata including a declaration of the declared host component model and a declaration of the abstract class definition;
obtaining access to data and functionality of the host software application via the customized application; and
providing customized output for the user that is different from host output provided by the host software application, the customized output generated by the customized application accessing, via the abstract class definition, the declared host component model, for accessing the same data and functionality that is accessed by the host software application.

16. The method of claim 15 wherein:
the customized output for the user includes visual output displayed on the graphical display, and
the client program is a browser.

17. The method of claim 16 wherein:
the customized output for the user includes at least one custom pane displayed on the graphical display that is a different arrangement of data that is displayed by executing the host software application.

18. The method of claim 15 wherein:
the customized output for the user includes nonvisual output.

19. The method of claim 18 wherein:
the customized output for the user includes triggering an event and storing a result of the event in a database.

20. The method of claim 15 wherein the declared host component model includes:
a controller declaration configured to indicate one or more run-time event handlers;
a data model declaration configured to indicate a structural description of data associated with the declared host component;
an input port declaration configured to indicate one or more run-time inputs to the declared host component; and
an output port declaration configured to indicate one or more run-time outputs from the declared host component.
